(19) United States
(12) Patent Application Publication
(10) Pub. No.: US 2026/0172272 A1
(43) Pub. Date: Jun. 18, 2026

(54) EXPEDITED USE OF A BLOCKCHAIN

(71) Applicant: M4tr1x Labs Inc., Bellevue, WA (US)

(72) Inventor: Zhunping Zhang, Mercer Island, WA (US)

(21) Appl. No.: 19/423,978

(22) Filed: Dec. 17, 2025

Related U.S. Application Data
(60) Provisional application No. 63/735,595, filed on Dec. 18, 2024.

(51) Int. Cl. H04L 9/00; A63F 13/73; H04L 9/32

(52) U.S. Cl. CPC H04L 9/50; A63F 13/73; H04L 9/3221

(57) ABSTRACT

A facility providing a verifiability cluster is described. The verifiability cluster is made up of multiple verifiability machines. Each has an interface adapted to receive a first input; software adapted to determine a result at least partly in response to the first input; and a verifiability mechanism. The verifiability mechanism collaborates with the other verifiability machines to aggregate the determined results to obtain an aggregate result; and generate verification evidence of the properness of the aggregate result. The aggregate result and generated verification evidence are amenable of being settled together to a blockchain.

### CROSS-REFERENCE TO RELATED APPLICATION(S)

This application claims the benefit of U.S. Provisional Patent Application No. 63/735,595, filed Dec. 18, 2024 and entitled “SPARSITY-REAL-TIME AND PARALLEL PROCESSING IN BLOCKCHAINS,” which is hereby incorporated by reference in its entirety.

In cases where the present application conflicts with a document incorporated by reference, the present application controls.

### BACKGROUND

Blockchain is a decentralized, distributed digital ledger that records transactions across a network of computers in linked “blocks.” Each block contains data, a timestamp, and a cryptographic hash of the previous block, making it immutable—any alterations require network consensus. Blockchain commonly provides data storage having the following characteristics: decentralization: no single point of control or failure; immutability: records can't be altered retroactively, enhancing security and trust; transparency: all participants can view transactions, promoting accountability; enhanced security: cryptography and consensus mechanisms resist tampering and fraud; and traceability: full audit trail for assets or data.

### BRIEF DESCRIPTION OF THE DRAWINGS

FIG. 1 is a dataflow diagram showing the operation of a conventional multiplayer game.

FIG. 2 is a block diagram showing some of the components typically incorporated in at least some of the computer systems and other devices on which the facility operates.

FIG. 3 is a dataflow diagram showing the operation of the facility to provide verifiable execution of a multiplayer game, the details and correctness of which is available for examination via the blockchain.

FIG. 4 is a flow diagram showing a process performed by the facility in some embodiments to operate a game or other application in a verifiable manner.

FIG. 5 is a dataflow diagram showing the use of the facility to delegate processing tasks from a blockchain network to a verifiability cluster.

FIG. 6 is a flow diagram showing a process performed by the facility in some embodiments to delegate a task from a blockchain network to a verifiability cluster.

### DETAILED DESCRIPTION

The inventors have recognized that, while conventional implementations of blockchain technology provide many advantages related to transparency and reliability, these advantages comes at the cost of processing speed: conventionally, blockchain is too slow to support many games, or throughput/latency-sensitive software systems of other types, such as high-frequency trading; real-time control of or response to automobiles, manufacturing equipment, robots, or other physical systems; autonomous agents; etc. For example, many kinds of games rely on client latency levels such as 20-200 ms.

The inventors have further recognized that many of these software systems would benefit significantly from the transparency and reliability of applying blockchain if existing limitations on its speed could be overcome. For example, successfully application of blockchain technology to low-latency games could ensure that games are operated fairly with respect to all players—e.g., that resources such as scored points, owned objects, character attributes are faithfully maintained in accordance with the game's rules for all players, and cannot be manipulated without detection by the purveyor or operator of game's software.

In response, the inventors have conceived and reduced to practice a software and/or hardware facility for expedited use of a blockchain (“the facility”). For example, in some embodiments, the facility enables the successful implementation of a speed-sensitive multiplayer game whose integrity is protected by a blockchain representation of aspects of the game's state. The facility performs work in a verifiability cluster of verifiability machines that together employ a verifiability mechanism. Through the verifiability mechanism, the verifiability machines compare the results of the work that they did; create an aggregate result; and establish verifiability evidence demonstrating the correctness of the aggregate result. The aggregate result is then settled to a blockchain, together with the verifiability result, such that anyone can later see the result and its verifiability evidence, and evaluate the verifiability evidence.

In the operation of the game, client game software executes on client devices on behalf of players of the game, receiving their inputs, determining a new local game state, and rendering outputs reflective of the new game state. Some or all of the inputs constitute interaction with a global state of the game, and, in some cases, other players and their local states. For example, a first player may take an action in which she attempts to grab a crown. While it is possible she will succeed, it's also possible that she will not because a different player nearby in the game's world earlier attempted to grab the crown. These interacting inputs are reconciled by sending them to a central computer executing game server software, which performs the reconciliation according to relevant game rules, such as that the first player in the proximity of an object to attempt the grab will succeed and have it added to their inventory. The game server software notifies the client devices of the result of the reconciliation, so that the game client software can adjust the players' local states to be consistent with the reconciliation result, and update the output being rendered to also be consistent with the reconciliation result. The game server software also adds the crown item to an inventory for the player who was successful in grabbing it.

In some embodiments, the application logic (such as game server software) is deterministic—that is, given the same inputs and initial state, the software always produces the same outputs. This determinism ensures that computation results can be verified, whether by comparing results across multiple machines (as in threshold signature techniques) or by cryptographic proof (as in ZK techniques).

In accordance with the facility, the game server software is adapted to be executed on each of a cluster of “verifiability machines.” In particular, the game server software is executed within a verifiability mechanism established on each of the verifiability machines of the cluster. When the game server software makes a determination with respect to the state of the game, the verifiability mechanism inside which the determination was made establishes evidence that the determination was performed properly. In particular, the verifiability mechanism relies on the repetition of execution of the game server software on each of the verifiability machines of the cluster, and on a demonstration of consensus among the results produced by the different verifiability machines.

In some cases, the reconciliation relies on state of the game that is local to the verifiability machines, “called game process data,” which is often of transient importance, and is stored only temporarily on the verifiability machines. The reconciliation results, however, are often of long-term importance, and are settled, together with its verifiability evidence, to a blockchain repository for long-term game state, called “core data” of the game. The core data is publicly visible and verifiable in the blockchain repository, establishing the properness and integrity of the game's operation. The core data stored in the blockchain repository is thereafter referred to by verifiability machines as part of the game's state in future reconciliations, including both machines of the verifiability cluster that settled this core data, and the machines of other verifiability clusters instantiated to process the game, either in parallel or in sequence with the verifiability cluster that settled this core data.

In some embodiments, verifiability clusters exist on a temporary basis, and are therefore sometimes called “ephemeral rollups.” For example, a new verifiability cluster may be established when the need for it begins—such as when one or more players begin playing the game—and is deallocated when the need for it ends-such as when the last of them stops playing the game. In some cases, the game is based in a virtual world divided by a spatial grid into tiles, between which players can travel. In some embodiments, a new verifiability cluster is established for each tile in which one or more players are present, and is deallocated once all of the players have left the tile. In some cases, pairs of tiles-such as pairs that are adjacent—are “bridged” to manage dependencies created between them by player actions.

In some embodiments, client devices maintain three distinct representations of application state, organized in a correction hierarchy: (1) a local prediction state, which reflects player inputs immediately with near-zero latency but without consideration of other players' actions; (2) a local consensus state, computed from player actions shared via the verifiability cluster but not yet subject to global consensus; When states diverge, the local consensus state correct the local prediction state through the rubberbanding technique, providing players with responsive interaction while maintaining consistency with authoritative consensus results; and (3) a consensus state, computed from actions that have achieved global consensus on the blockchain.

In some embodiments, rather than the blockchain being driven by the verifiability clusters to reliably store data created by the verifiability clusters, verifiability clusters are instead used as workers invoked by the blockchain. In particular, where a computationally-intensive task is to be performed by the blockchain that is amenable of parallelization, the blockchain instantiates a verifiability cluster to perform a parallelized implementation of the task. The correctness of the task's results produced by the verifiability cluster is demonstrated by verifiability evidence generated by the verifiability cluster, which is then settled together with the task result to the blockchain.

By operating in some or all of the ways described above, the facility adapts the security of blockchain storage to applications involving or requiring high-speed processing.

Additionally, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, hardware nodes of a blockchain network that use the facility to delegate processing to a verifiability cluster themselves have a lower processing burden than hardware nodes not performing this delegation. As a result, less powerful blockchain nodes may be deployed, or the same blockchain nodes may be used to handle a larger flow of transactions. Additionally, in some cases it is true that the aggregate level of processing across both of the blockchain and verifiability machines is lower for the task. Also, many of the tasks that are performed in the verifiability machines are processed at a lower level of latency than if they were performed in the blockchain nodes.

Further, for at least some of the domains and scenarios discussed herein, the processes described herein as being performed automatically by a computing system cannot practically be performed in the human mind, for reasons that include that the starting data, intermediate state(s), and ending data are too voluminous and/or poorly organized for human access and processing, and/or are a form not perceivable and/or expressible by the human mind; the involved data manipulation operations and/or subprocesses are too complex, and/or too different from typical human mental operations; required response times are too short to be satisfied by human performance; etc. For example, it would be meaningless in a scheme of verifiability via consensus to repeat the same processing in a single human mind that is attributed by the facility to distinct, independent verifiability machines. Performing even a single repetition of this processing in a human mind could never be adequate to satisfy latency needs of many real-time games, let alone the multiple repetitions prescribed by the facility, which in the human mind would need to be performed in series rather than in parallel, thus multiplying the latency incurred by the human mind.

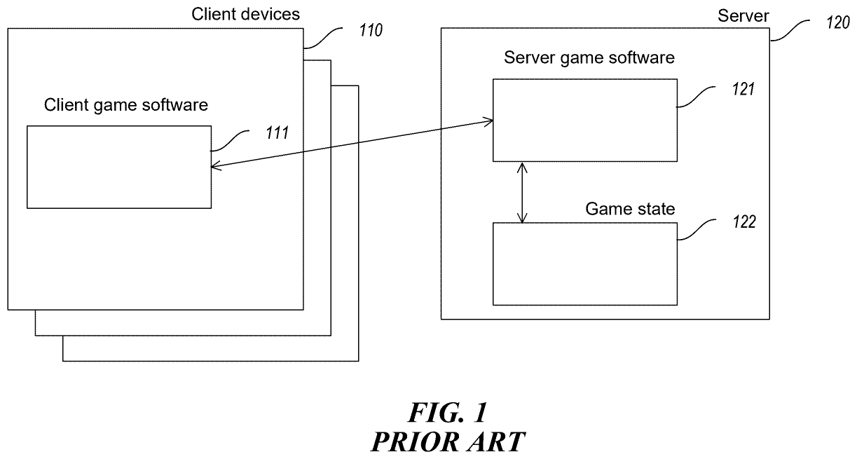

FIG. 1 is a dataflow diagram showing the operation of a conventional multiplayer game. It shows a number of client devices 110, each used by a different player playing the game. These client devices may be of a wide variety of device types that are capable of receiving game inputs from the user player, and rendering game outputs to the player. Game client software 111 executes on each of the client devices. When game inputs are received from a player, the client game software determines a new local game state that reflects the inputs, and renders outputs that reflect the new game state. It also communicates the inputs to server game software 121 executing on a central server 120. The server game software determines how, if at all, the game input received from the client device should affect a state 122 of the game maintained by the server. In various approaches, the server game software makes this determination based upon rules and processes specified for the game; elements of the existing game state; and/or game inputs given by other players, such as contemporaneous game inputs. If the server game software determines that the game state should be changed in response to the input, the server game software communicates at least the changed elements of the game state to client game software on the client device providing the input, and potentially one or more additional client devices that are affected by the change to the game state.

In this conventional approach to game operation, the players rely on the providers of the server game software and the operator of the server to faithfully apply the rules and processes for operating the game. If either of these actors modified the behavior of the server game software to disadvantage particular players, or give unmerited advantages to other players, this would be difficult to detect, and even more difficult to prove.

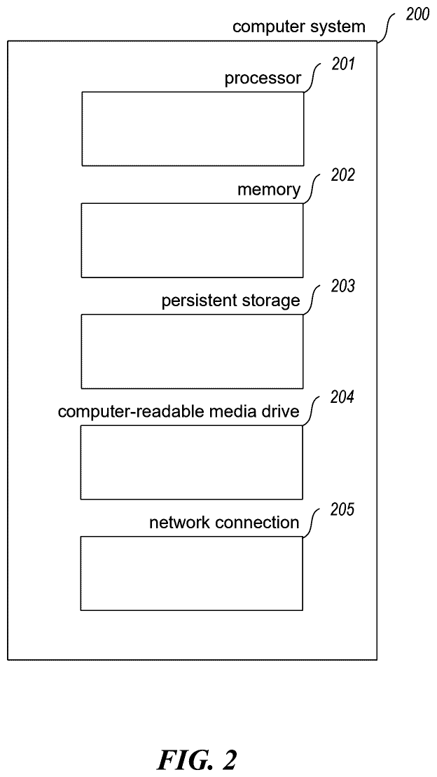

FIG. 2 is a block diagram showing some of the components typically incorporated in at least some of the computer systems and other devices on which the facility operates. In various embodiments, these computer systems and other devices 200 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 201 for executing computer programs and/or training or applying machine learning models, such as a CPU, GPU, TPU, NNP, FPGA, or ASIC; a computer memory 202 for storing programs and data while they are being used, including the facility and associated data, an operating system including a kernel, and device drivers; a persistent storage device 203, such as a hard drive or flash drive for persistently storing programs and data; a computer-readable media drive 204, such as a floppy, CD-ROM, or DVD drive, for reading programs and data stored on a computer-readable medium; and a network connection 205 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. None of the components shown in FIG. 2 or discussed above constitutes a data signal per se. While computer systems configured as described above are typically used to support the operation of the facility, those skilled in the art will appreciate that the facility may be implemented using devices of various types and configurations, and having various components.

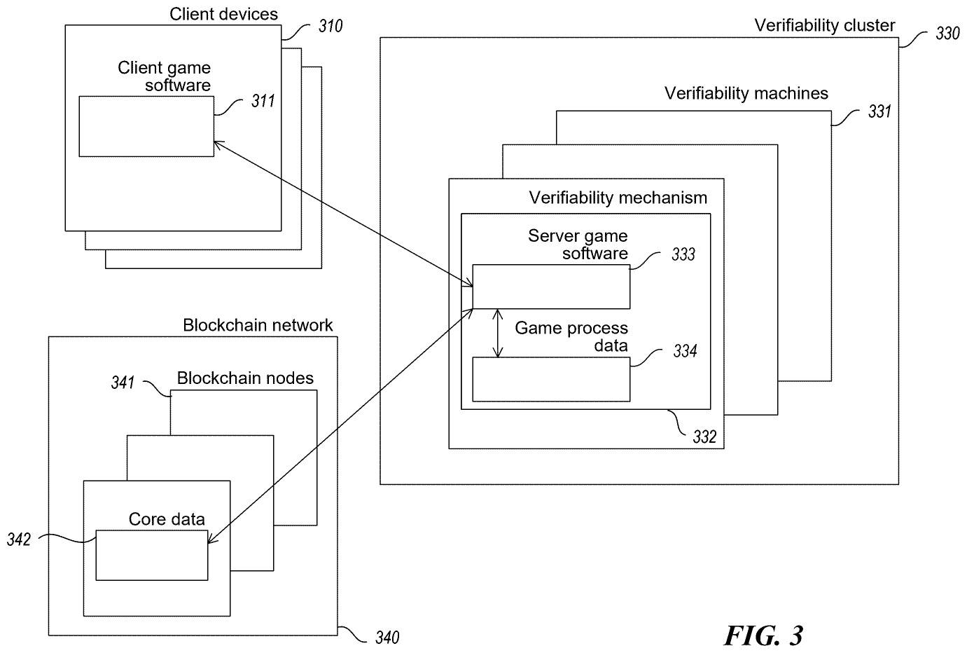

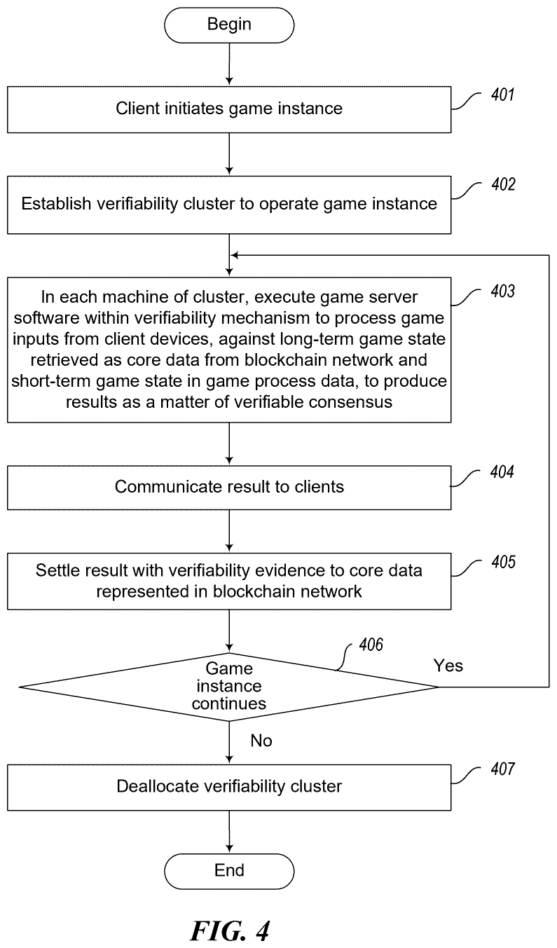

FIG. 3 is a dataflow diagram showing the operation of the facility to provide verifiable execution of a multiplayer game, the details and correctness of which is available for examination via the blockchain. This data flow can be compared and contrasted to that shown in FIG. 1 and discussed above. In particular, this approach provides a level of verifiability and transparency not available in the conventional approach illustrated in FIG. 1. While the operation of the facility on behalf of client devices is shown here and in FIG. 4 with respect to gaming, it will be appreciated by those skilled in the art that the same approach can be straightforwardly adapted to applications of a variety of other types.

The client game software 311 executing on client devices 310 operates in a manner similar to client game software 111 shown in FIG. 1. In some cases, the client device and client game software are referred to as a “no-consensus layer” that can operate quickly without any attempt to achieve consensus between multiple computing notes. The client game software 111 communicates with server game software 333. The server game software 333 executes on each of multiple verifiability machines 331 that make up a verifiability cluster 330. In some embodiments, the verifiability machines are virtual machines. In some embodiments, the verifiability machines are individual physical machines.

In particular, the server game software 333 executes inside a verifiability mechanism 332. The verifiability mechanism establishes the correctness of computation results. In some embodiments using threshold signature verifiability techniques, the verifiability mechanism connects multiple machines and evaluates outcomes produced by each machine for the same input, requiring agreement among a threshold number of machines. In embodiments using Trusted Execution Environment (TEE) verifiability techniques, a single machine executing within a TEE generates cryptographic attestation of correct execution without requiring comparison among multiple machines. In embodiments using zero-knowledge proof verifiability techniques, a single machine may generate a cryptographic proof of computational correctness without requiring result comparison among multiple machines. In processing each game input, the server game software consults elements of the game's short-term state represented as game process data 334 present on the verifiability machines, and/or longer-term game state stored as core data 342 in a blockchain repository maintained by one or more blockchain nodes 341 making up a blockchain network 340. In some embodiments, verifiability machines perform lazy loading of application state from the blockchain. Rather than initializing with a complete copy of blockchain state, verifiability machines clone relevant state on-demand as transactions reference particular accounts or data. This lazy loading enables rapid cluster initialization without the overhead of full state synchronization.

When, for a particular game input, the server game software generates a game outcome on each of the verifiability machines, the verifiability mechanism compares those game outcomes, and aggregates them into an aggregate outcome or result. The verifiability mechanism also generates information—sometimes called verification evidence—that supports the proposition that the game outcome or result is proper in light of the input and game state. In some embodiments, the verifiability cluster is referred to as a “local consensus layer,” whose consensus is established by the verifiability mechanism. The communication between the no-consensus layer and the local consensus layer is sometimes performed using a rubberbanding technique that provides the illusion of real-time interaction to the player. In cases where the game outcome determined by the verifiability cluster differs from a game outcome assumed by the client, the client adjusts its local state and output to reflect the game outcome produced by the verifiability cluster.

In various embodiments, the facility incorporates verifiability mechanisms of various types. For example, in various embodiments, the facility employes verifiability mechanisms implementing one or more of the verifiability techniques shown below in Table 1.

TABLE 1

| Technique | Title | URL |
|---|---|---|
| threshold | Multiparty | https://github.com/ing-bank/threshold- |
| signature | threshold | signatures/blob/master/README.md |
| verifiability | ECDSA | |
| technique | scheme | |
| trusted | Hardware- | https://confidentialcomputing.io/wp- |
| execution | Based Trusted | content/uploads/sites/10/2023/03/CCC_{—} |
| environment | Execution for | outreach_whitepaper_updated_{—} |
| verifiability | Applications | November_2022.pdf |
| technique | and Data | |
| naysayer | Naysayer | https://eprint.iacr.org/2023/1472.pdf |
| proof | proofs | |
| verifiability | | |
| technique | | |
| zero- | Ultimate | https://www.rapidinnovation.io/post/what- |
| knowledge | Guide to | are-the-step-by-step-processes-for- |
| proof | Implementing | implementing-zkps-in-a-blockchain- |
| verifiability | Zero- | project |
| technique | Knowledge | |
| | Proofs in | |
| | Blockchain | |

For each of the verifiability techniques shown in Table 1, a document is identified that describes how to implement that verifiability technique. Each of these documents is hereby incorporated by reference in its entirety.

Additionally, in some embodiments, the facility implements a variability mechanism that uses an opportunistic proof technique, an opportunistic zero-knowledge proof technique, or both. In the opportunistic proof technique, the outcome can be challenged using a bisection fault proof process arbitrated by smart contracts on the blockchain. The opportunistic zero-knowledge proof technique involves dividing the computation of the result into chunks, and recording state snapshots after the processing of each chunk. A challenger can examine the trace made up of the state snapshots; if the trace contains errors, the challenger can isolate the first erroneous chunk, and generate zero-knowledge proof proving the divergence in the chunk, and complete fault proof processing on-chain with a zero knowledge verification. Because the opportunistic zero-knowledge proof technique does not depend on interactive bisection, it is more space efficient, since only snapshots need to be stored.

In embodiments using opportunistic proof or opportunistic zero-knowledge proof techniques, the inputs and actions (collectively, ‘process data’) used to compute a result are stored in a data availability layer during a challenge period. This data availability layer may comprise compressed on-chain storage, an external data availability network such as Celestia, or other persistent storage accessible to potential challengers. After the challenge period expires without successful challenge, process data may be discarded while the settled result remains permanently recorded on the blockchain.

Different verifiability techniques carry different security assumptions. Threshold signature techniques assume that at least two-thirds of verifiability machines are honest (i.e., at most one-third are malicious or compromised). Trusted Execution Environment techniques assume the hardware enclave has not been compromised. Opportunistic proof techniques assume at least one honest and online challenger exists during the challenge period. Zero-knowledge proof techniques provide unconditional computational security requiring no honesty assumptions about the proving machine.

In some embodiments employing consensus protocols within the verifiability cluster, the facility implements a forced proposer inclusion mechanism to ensure real-time responsiveness. Before a block proposer proposes a new block, all nodes share bundles of received player actions with each other. The proposer must include actions from at least one-third of the received bundles, taking the union of actions across included bundles. This mechanism prevents censorship of player actions and ensures timely processing of all inputs.

In some embodiments, game progression operates in discrete time units called “ticks,” where each tick represents a fixed time interval (e.g., 40 milliseconds). Player actions include timestamps signed by the originating player. Using synchronized clocks among players and verifiability machines, each action is deterministically assigned to a tick based on its timestamp. Actions arriving after a threshold delay (e.g., exceeding 5 ticks) are also discarded to maintain real-time responsiveness. This timestamp-based filtering ensures deterministic ordering of player actions across all verifiability machines.

Having completed this process, one or more of the verifiability machines reports the game outcome to the client game software one or more of the client devices, which the client processes as described above in connection with FIG. 1. One or more of the verifiability machines also causes the game outcome to be settled as an update to the core data in the blockchain network. This settlement includes with the game outcome the verifiability evidence generated by the verifiability mechanism. The blockchain and its smart contracts are sometimes referred to as a “global consensus layer,” in which results from multiple verifiability clusters are composed into the long-term state of the game.

Once settled to the blockchain network with its verifiability evidence, the game outcome is available for examination by game players and other members of the public. This settled data will always be available unchanged for access and evaluation.

FIG. 4 is a flow diagram showing a process performed by the facility in some embodiments to operate a game or other application in a verifiable manner. In act 401, a client initiates a game instance. In act 402, if a verifiability cluster suitable for running the game on behalf of the client is not already in operation, the facility establishes a new verifiability cluster to operate this game instance. This may be true, for example, when no players have played the game for a period of time; where when no players have played a particular aspect of the game for a period of time, such as by being located in or acting within a particular tile in a grid of tiles making up a virtual world represented in the game.

In act 403, in each machine of the verifiability cluster, the facility executes game server software within a verifiability mechanism. The game server software processes game inputs from client devices against two forms of game state: long-term game state retrieved as core data from the blockchain network, and short-term game state in game process data maintained locally in the verifiability machines. This processing of game inputs produces a game outcome or result as a matter of verifiable consensus among the verifiability machines. In act 404, the facility communicates the game outcome or result to clients to which it is relevant, i.e., clients whose players are affected by the change in game state that the outcome represents. In act 405, the facility settles the produced result, along with the verifiability evidence produced by the verifiability mechanism, to core data represented in the blockchain network.

In act 406, if the game instance is to continue operating, then the facility continues in act 403 to receive and process the next game input, else the facility continues in act 407 to deallocate the verifiability cluster. After act 407, this process concludes. For example, the facility may determine that the game instance does not continue if all of the players have left the game, or all of the players have been idle for a threshold amount of time, or all of the players have left a tile or other aspect of the game to which the verifiability cluster corresponds.

Those skilled in the art will appreciate that the acts shown in FIG. 4 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

In some embodiments, the facility performs bridging in the blockchain to coordinate the settlement of game outcomes determined by different verifiability clusters, by resolving dependencies between different verifiability clusters, as discussed below. If a game outcome does not depend on anything else, it can be immediately settled on-chain. If the game outcome depends on other game outcomes that have not been settled, the facility listens to chain messages and waits until the game outcome's dependencies are cleared.

In some embodiments, all dependencies are unidirectional and they can be seen as bridging between verifiability clusters. In some embodiments, the word “bridge” refers to transfer of both assets and information. In some embodiments, there are four types of verifiability cluster bridging:
Spawning bridge: A first verifiability cluster spawns a second verifiability cluster. The second verifiability cluster's input is provided by the first verifiability cluster and therefore has a dependency on the first verifiability cluster.
Merging bridge: A first verifiability cluster merges into a second verifiability cluster. The second verifiability cluster takes data from the first verifiability cluster and depends on the first verifiability cluster.
Continuation bridge: A first verifiability cluster spawns a second verifiability cluster, and then merges into it. Essentially the first verifiability cluster's execution continues in the second verifiability cluster. This can be seen as a spawning+merging bridge. Continuation bridge is unique in the sense that the underlying verifiability cluster nodes do not need to be changed. The second verifiability cluster can continue using the same set of nodes from the first verifiability cluster.
Transfer bridge: Both a first verifiability cluster and a second verifiability cluster already exist. The first verifiability cluster bridges some data to the second verifiability cluster.

A developer can use an SDK provided by the facility in some embodiments to express a complex computation using these four types of bridges. During the execution of the computation, verifiability clusters can be spun up and torn down. The developer can choose a level of granularity that strikes a balance between verifiability cluster overhead and parallelizability.

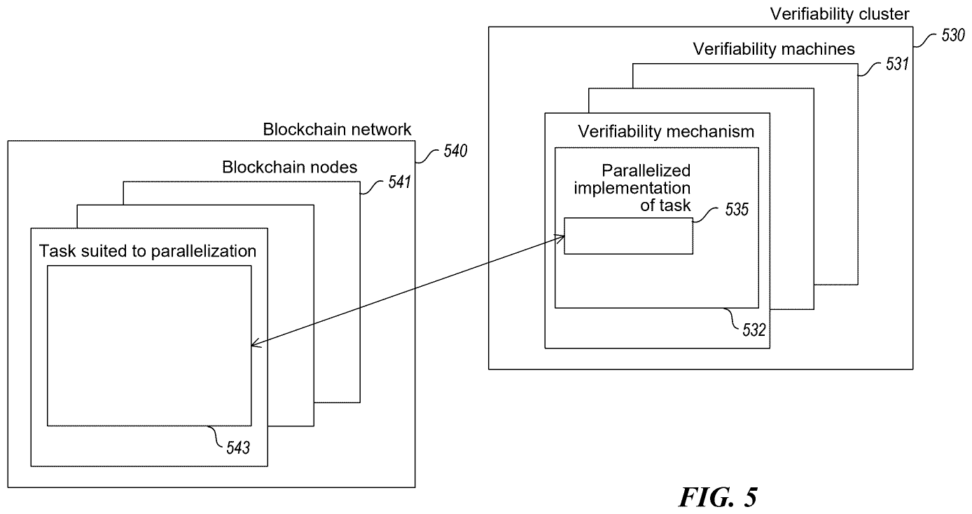

FIG. 5 is a dataflow diagram showing the use of the facility to delegate processing tasks from a blockchain network to a verifiability cluster. In a blockchain network 540, one of the blockchain nodes 541 encounters a processing-intensive task to be performed on the blockchain node. Rather than allocating processing resources local to the blockchain node to this task, the facility delegates the task to a parallelized implementation of the task 535 that runs within a verifiability mechanism 532 on each of the verifiability machines 531 of a verifiability cluster. In some embodiments, the verifiability cluster is dynamically allocated at the time the task is delegated, and/or dynamically deallocated at the time performance of the task is completed. In a manner similar to that described above in connection with FIGS. 3 and 4, the facility performs the parallelized implementation of the task across the verifiability machines, reaching a result on each. The verifiability mechanism examines the results to produce an aggregate result. It also generates verifiability evidence for the aggregate result. One or more of the verifiability machines reports the result and the verifiability evidence to the blockchain network, where the result and verifiability evidence are settled against the blockchain.

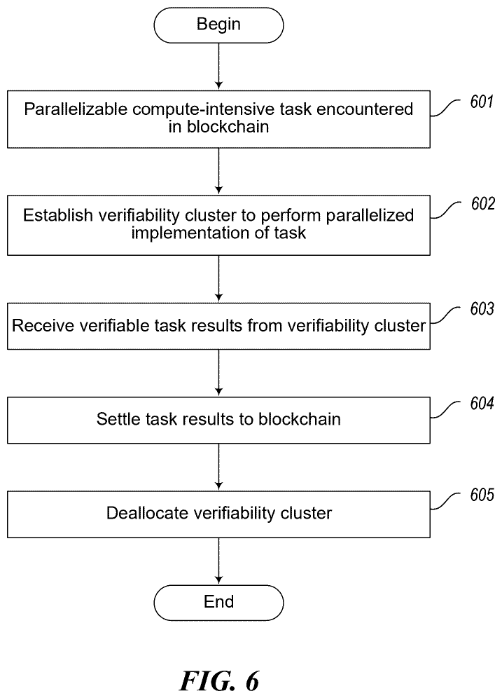

FIG. 6 is a flow diagram showing a process performed by the facility in some embodiments to delegate a task from a blockchain network to a verifiability cluster. In act 601, the facility determines that a parallelizable compute-intensive task has been encountered in the operation of the blockchain. In act 602, the facility establishes a verifiability cluster to perform parallelized implementation of the task if it is not already operating. In act 603, the blockchain receives verifiable task results from the verifiability cluster: the result, and verifiability evidence supporting the result. In act 604, the facility settles the task results produced by the verifiability cluster to the blockchain, along with the verifiability evidence. In act 605, the facility deallocates the verifiability cluster. After act 605, this process concludes.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method in a computing system, comprising;
receiving an indication of a first player seeking to participate in a game;
in response to the received indication, allocating a first cluster of machines to each execute first software implementing the game in a verifiability mechanism;
in each machine of the first cluster:
receiving a first game input originated by the first player;
with the first software implementing the game, determining a first game outcome at least partially based on the first game input; and
with the verifiability mechanism, interacting with the other machines of the first cluster to generate first verification evidence of the properness of the first game outcome;
responding to the first game input by causing a first response comprising an indication of the first game outcome to be transmitted to a first device being used by the first player; and
causing the first game outcome to be settled, together with the first verification evidence, to a blockchain repository established to represent game states of the game.

2. The method of claim 1, further comprising:
in response to determining that a level of activity of the first cluster has fallen below an activity level threshold, deallocating the machines of the first cluster.

3. The method of claim 1 wherein the verifiability mechanism implements a threshold signature verifiability technique, a trusted execution environment verifiability technique, an opportunistic proof verifiability technique, an opportunistic zero-knowledge proof verifiability technique,
a naysayer proof verifiability technique, or a zero-knowledge proof verifiability technique.

4. The method of claim 1 wherein the first response directs second game software implementing the game executing on the first device to:
adjust a local game state of the first device; and
generate game output reflecting the adjusted local game state.

5. The method of claim 1, further comprising:
in each machine of the first cluster:
contemporaneous with receiving the first game input, receiving a second game input originated by a second player distinct from the first player, wherein the determination of the first game outcome is also based on the second game input, and comprises a resolution of the first game input with the second game input, the method further comprising:
responding to the second game output by causing a second response comprising an indication of the first game outcome to be transmitted to a second device being used by the second player.

6. The method of claim 1, further comprising:
in each machine of the first cluster:
accessing the blockchain repository to retrieve a first state of the game, wherein the determination of the first game outcome is also based on the retrieved first state of the game.

7. The method of claim 6 wherein the first state of the game reflects a second game input originated by a second player distinct from the first player at a time before the first game input was originated by the first player.

8. The method of claim 1 wherein the first cluster of machines is among a plurality of clusters of machines, each cluster of the plurality of clusters representing a different aspect of the game.

9. The method of claim 8 wherein each cluster of the plurality of clusters representing a different spatial region of a virtual world represented in the game.

10. The method of claim 9, further comprising:
identifying a second spatial region adjacent to the first spatial region represented by the first cluster; and
in anticipation of a player traversing from the first spatial region to the second spatial region, preemptively allocating a second cluster to the second spatial region before the player enters the second spatial region.

11. The method of claim 8, further comprising:
identifying a dependency upon the first cluster by a second cluster of the plurality of clusters distinct from the first cluster; and
suspending at least some operations of the second cluster until determination of the first game outcome occurs.

12. The method of claim 10 wherein the second cluster reuses the same verifiability machines as the first cluster, such that execution continues on the same machines without reallocation, and wherein the second cluster inherits state from the first cluster without inter-machine data transfer.

13. The method of claim 8, further comprising:
in response to determining that a player has begun interacting with a second aspect of the game not represented by one of the plurality of clusters, allocating a new cluster to the second aspect of the game; and
in response to determining that no player is presently interacting with the aspect of the game, deallocating the first cluster.

14. The method of claim 1 wherein a plurality of verifiability clusters produce a plurality of outcomes that are settled to the blockchain repository in accordance with a directed acyclic graph structure,
wherein edges of the directed acyclic graph represent dependencies between outcomes of different verifiability clusters,
and wherein settlement of a first outcome is deferred until settlement of all outcomes upon which the first outcome depends.

15. (canceled)

16. The method of claim 1, further comprising:
receiving a plurality of game inputs, each game input including a timestamp;
discarding game inputs having timestamps that precede the current time by more than a threshold delay; and
processing remaining game inputs in an order determined by their timestamps.

17. One or more memories collectively having contents configured to cause a computing system to perform a method, the method comprising:
receiving a first input with respect to a software system originated by a first user using a first device;
distributing the first input to a first cluster of machines, each of the machines of the first cluster executing first software implementing the software system in a verifiability mechanism;
in each machine of the first cluster:
with the first software, determining a first outcome at least partially based on the first input; and
with the verifiability mechanism, interacting with the other machines of the first cluster to generate first verification evidence of the properness of the first outcome;
responding to the first input by causing a first response comprising an indication of the first outcome to be transmitted to the first device; and
causing the first outcome to be settled, together with the first verification evidence, to a blockchain repository established to represent states of the software system.

18. The one or more memories of claim 17 wherein the software system is a multiplayer game, a real-time control system for physical systems, or a securities trading system.

19. The one or more memories of claim 17, the method further comprising:
receiving an indication that the first user is seeking to use the software system; and
in response to the received indication, allocating the first cluster of machines.

20. The one or more memories of claim 17, the method further comprising:
in response to determining that a level of activity of the first cluster has fallen below an activity level threshold, deallocating the machines of the first cluster.

21. The one or more memories of claim 17 wherein the verifiability mechanism implements a threshold signature verifiability technique.

22. The one or more memories of claim 17 wherein the verifiability mechanism implements a trusted execution environment verifiability technique.

23. The one or more memories of claim 17 wherein the verifiability mechanism implements an opportunistic proof verifiability technique.

24. The one or more memories of claim 17 wherein the verifiability mechanism implements an opportunistic zero-knowledge proof verifiability technique.

25. The one or more memories of claim 17 wherein the verifiability mechanism implements a naysayer proof verifiability technique.

26. The one or more memories of claim 17 wherein the verifiability mechanism implements a zero-knowledge proof verifiability technique.

27. A method in a computing system, comprising:
in response to identifying a compute-intensive task to be performed in a blockchain:
delegating a parallel processing implementation of the task to a cluster of verifiability machines;
receiving a result determined for the task by the cluster, together with verification evidence of the properness of the result determined by the cluster; and
causing the result to be settled, together with the verification evidence, to the blockchain.

28. The method of claim 27, further comprising:
in response to identifying a compute-intensive task to be performed in the blockchain:
causing the verifiability machines of the cluster to be allocated.

29. The method of claim 27, further comprising:
in response to receiving the result:
causing the verifiability machines of the cluster to be deallocated.

30. The method of claim 27 wherein the verifiability mechanism implements a threshold signature verifiability technique, a trusted execution environment verifiability technique, an opportunistic proof verifiability technique, a naysayer proof verifiability technique, or a zero-knowledge proof verifiability technique.

31. A computing system, comprising:
a plurality of verifiability machines, each comprising:
an interface adapted to receive a first input;
software adapted to determine a result at least partly in response to the first input; and
a verifiability mechanism adapted to collaborate with the other verifiability machines of the plurality to:
aggregate the determined results to obtain an aggregate result; and
generate verification evidence of the properness of the aggregate result, such that the aggregate result and generated verification evidence are amenable of being settled together to a blockchain.

32. The computing system of claim 31, further comprising:
a blockchain node adapted to settle the aggregate result and generated verification evidence to the blockchain.

33. The computing system of claim 31 wherein the first input is sent from a client device distinct from the plurality of machines and the blockchain node.

34. The computing system of claim 31 wherein the first input is sent from the blockchain node.

35. The computing system of claim 31 wherein each verifiability machine is a different virtual machine implemented on a physical machine.

36. The computing system of claim 31 wherein each verifiability machine is a different physical machine.

37. A method in a computing system, comprising:
dividing a computation into a plurality of sequential chunks;
for each chunk, recording a state snapshot representing the state after processing that chunk;
storing the state snapshots in a data availability layer; and
in response to a challenge:
receiving an identification of a first chunk alleged to contain an error;
generating a zero-knowledge proof demonstrating that the recorded state snapshot following the first chunk is inconsistent with correct execution of the first chunk given the state snapshot preceding the first chunk; and
settling the challenge result to a blockchain based on verification of the zero-knowledge proof.
